(19) United States
(12) Patent Application Publication
(10) Pub. No.: US 2010/0055954 A1
(43) Pub. Date: Mar. 4, 2010

(54) SEALED ELECTRICAL CONNECTOR

(75) Inventors: Galen M. Martin, Camp Hill, PA (US); David W. Murray, Jamestown, NC (US)

Correspondence Address: TYCO TECHNOLOGY RESOURCES, 4550 NEW LINDEN HILLS ROAD, SUITE 140, WILMINGTON, DE, 19808, US

(73) Assignee: Tyco Electronics Corporation, Berwyn, PA (US)

(21) Appl. No.: 12/201,408

(22) Filed: Aug. 29, 2008

(51) Int. Cl. H01R 13/52

(52) U.S. Cl. 439/278

(57) ABSTRACT

A connector assembly is comprised of a connector housing and a terminal position assurance member (TPA). The connector housing has an outer shroud wall which defines a gap between a central body portion of the connector housing. The TPA has an integrally co-molded seal thereon, which is receivable in the gap when the TPA is in position.

### FIELD OF THE INVENTION

The subject application relates to a sealed electrical connector, and more particularly to a co-molded seal attached to an auxiliary housing component.

### RELATED APPLICATION

This application is related to application Ser. No. ______ (Attorney Docket E-AV-00358) concurrently filed herewith, the entirety of which is incorporated herein.

### BACKGROUND OF THE INVENTION

Multiple sealed electrical connectors designs exist in the art. Some designs have discreet wire seals, while others have planar seals and/or interfacial seals between mating electrical connector halves. It is also known to have electrical connectors where a central body portion is surrounded by a shroud where a mating connector is positioned over the central body portion and intermediate the shroud, see for example the prior art connector shown in FIG. 1. In this case a seal “C” is normally positioned in a surrounding relationship to the central body portion of housing “A” and has sealing ribs which generally extend in a direction transverse to a longitudinal direction of the central body portion. A terminal position assurance member (TPA) “B” may be positioned into housing A to ensure proper loading of the terminals. The ribs as profiled are in sealing engagement with a mating connector when the mating connector is positioned intermediate the central body portion and the shroud whereby the seal is compressed to effect sealing engagement between the central body portion and the mating connector.

In an effort to simplify the manufacturing and assembly processes of electrical connectors, it would be desirable to have a seal co-molded to the housing assembly to effect the sealing. It is generally known to provide a co-molded or dual molded seal on an electrical connector housing, see for example, U.S. Pat. Nos. 4,772,231 and 4,961,713. While the dual molding process simplifies the manufacturing process, dual molding in a situation as described above, in a shrouded-type electrical connector is difficult to achieve due to the location of the seal. That is, a molding machine which molds the plastic portion of a shrouded connector has a die which is drawn in a direction away from the electrical connector (along the mating axis) to form a gap between the central body portion and the shroud. It is in that same gap where the seal needs to reside. Thus it is difficult to provide molding equipment which, after molding the gap between the central body portion and the shroud, can thereafter also mold an integrated seal. It is an object herein to provide an integrated seal with the connector assembly.

### BRIEF SUMMARY OF THE INVENTION

The objects have been accomplished by providing an electrical connector assembly having a housing member comprised of a housing central body portion defining a body surface. The body portion further comprises at least one terminal receiving cavity extending therethrough, and a wall portion overlying the body surface, defining a gap therebetween. An auxiliary housing portion having an integrally molded seal thereon is receivable in the gap, with the seal generally overlying the body surface.

In another embodiment, a sealed electrical connector comprises a housing member having a housing body portion defining an outer wall having a body surface, and at least one terminal receiving cavity extending through the housing body portion. The housing member further comprises a shroud member overlying the body surface, defining a gap therebetween. A terminal position assurance member (TPA) having a TPA wall is receivable in the gap, and has a seal attached to a free end thereof, where the seal is positioned over the body surface, when the TPA wall is positioned over the outer wall.

A method of forming a sealed electrical connection comprises the steps of molding overlying connector housing walls with a gap therebetween; molding an auxiliary wall, and co-molding an integral seal to a free end of the auxiliary wall; and inserting the auxiliary wall and integral seal into the gap, with the seal in substantial contact with one of the connector walls.

### BRIEF DESCRIPTION OF THE DRAWINGS

FIG. 1 is a perspective view of a prior art connector system with a discreet circumferential seal;

FIG. 2 shows a front perspective view of the assembled electrical connector of the present disclosure;

FIG. 3 shows an exploded view of the electrical connector of FIG. 2 together with an electrical terminal poised for receipt, and a mating connector poised for connection to the connector assembly;

FIG. 4 is a perspective view similar to that of FIG. 3, shown from the opposite perspective;

FIG. 5 is a cross-sectional view through lines 5-5 of FIG. 3;

FIG. 6 is a cross-sectional view similar to that of FIG. 5 showing the electrical terminal position assurance member in a first pre-latched condition;

FIG. 7 shows a view similar to that of FIG. 6 with the electrical terminal shown in a partially inserted position; and

FIG. 8 shows the terminal position assurance member in its second or fully locked condition, and the TPA in a fully locked position.

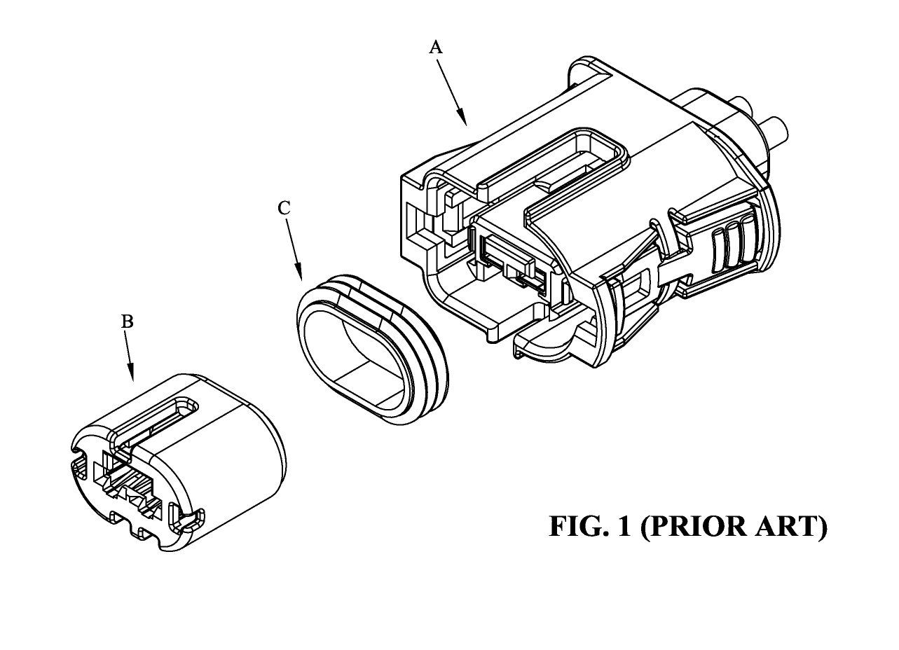

### DETAILED DESCRIPTION OF THE INVENTION

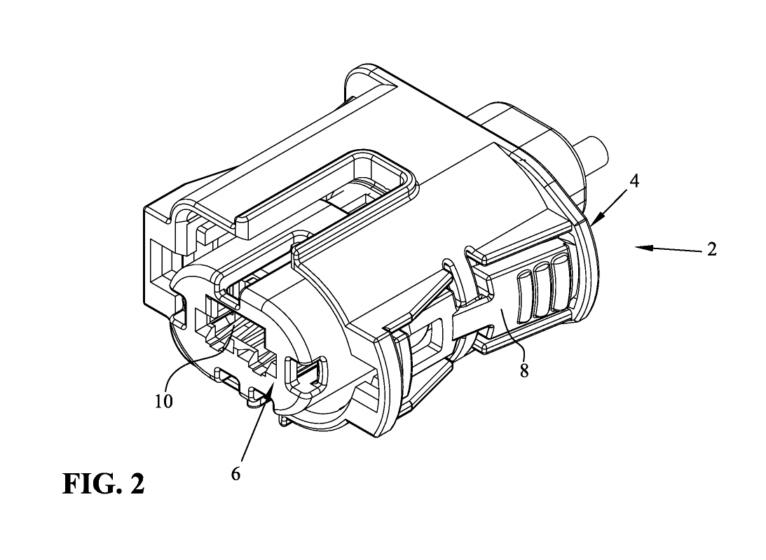

With reference first to FIG. 2, the electrical connector assembly is shown at 2 which is generally comprised of a connector housing member 4 and an auxiliary connector component, in this case shown as a terminal position assurance member (TPA) 6. The connector housing 4 would generally include latches 8 for connection to a mating connector and a terminal receiving cavity 10 would be formed by the combination of TPA 6 and connector housing 4.

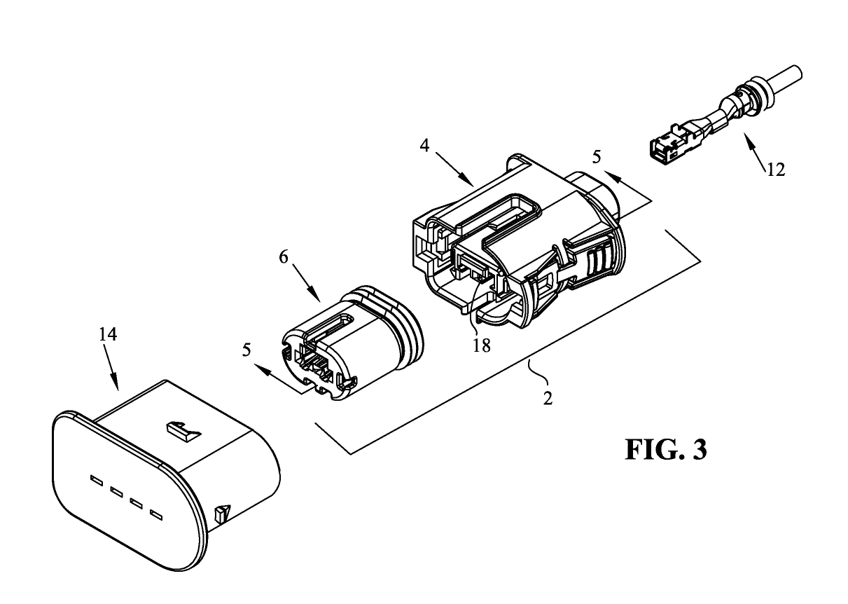

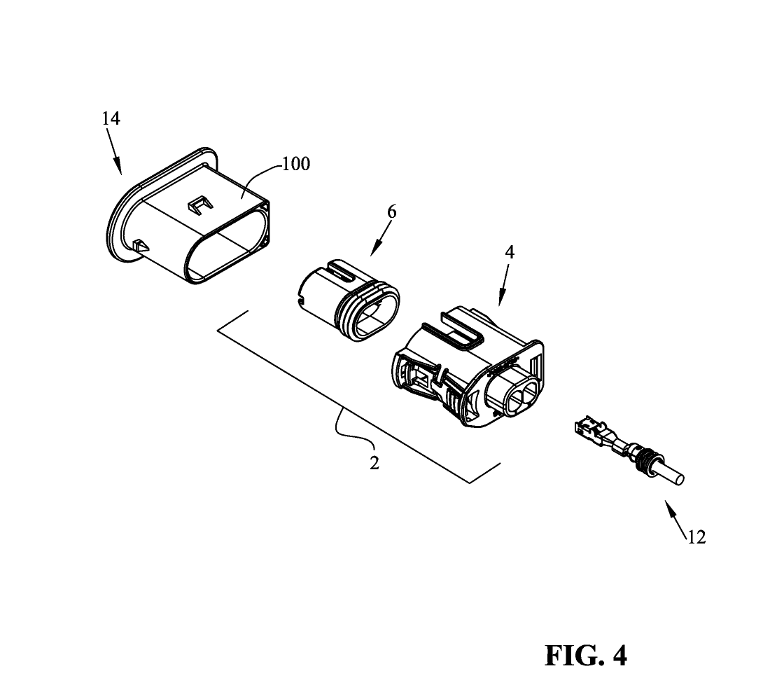

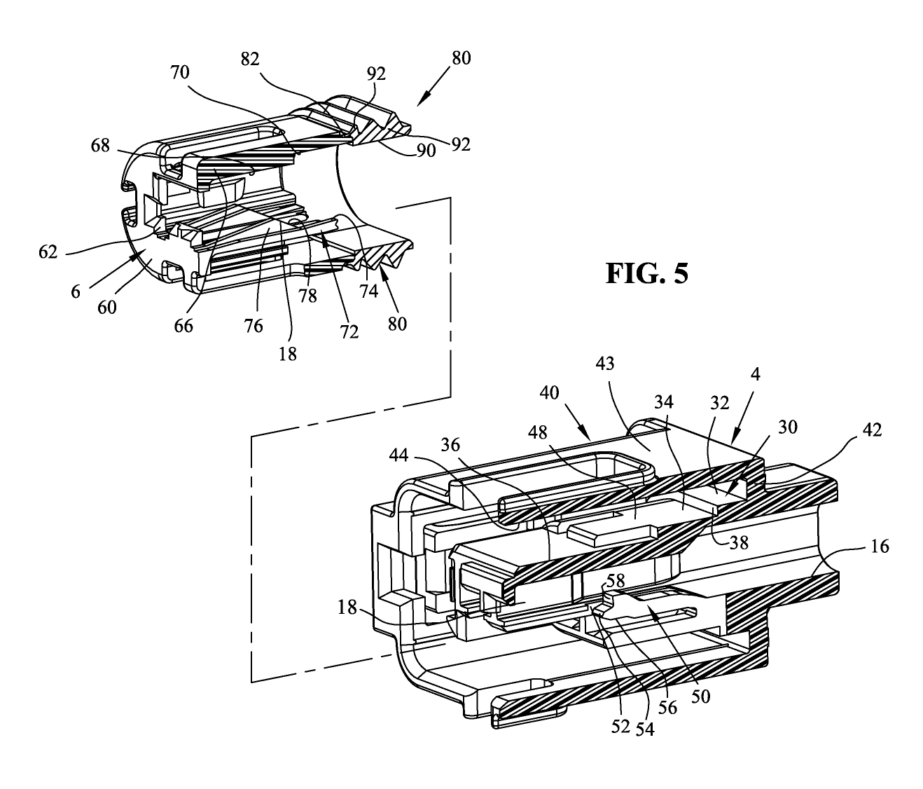

With reference now to FIGS. 3 and 4, TPA member 6 is shown in an exploded manner away from connector housing 4 and electrical terminal 12 is shown poised for receipt from a rear side of connector housing 4. A mating connector 14 is shown poised from a front side of connector assembly 2, which would be complementary with connector assembly 2. It should be understood that the mating connector 14 is shown somewhat generically, in that it could take many forms. It could be another connector housing having a plurality of wires connected thereto, or alternatively, could have a printed circuit board mounted thereto. Still alternatively, mating connector 14 could be a portion of an electronic device such as a controller, or the like. As shown best in FIG. 4, terminal 12 would be receivable through a rear entry 16 (FIG. 5) for positioning within cavity portion 18 (FIG. 3).

With respect now to FIG. 5, the connector housing 4 will be described in greater detail. Connector housing 4 is defined by a housing central body portion 30 defining a body surface comprised of a first outer surface 32, a first undercut surface at 34, and a second undercut surface at 36. The intersection of surfaces 32 and 34 also define shoulder 38. A shroud 40 is integrally connected to the central body portion 30 at a position 42 where the shroud wall 40 extends forwardly therefrom. Shroud 40 has a wall 43 with an internal surface defined at 44 which together with the surfaces 32, 34 and 36 define a gap 48 therebetween. As also shown in FIG. 5, an integrated latch 50 extends between the rear entry portion 16 and the cavity portion 18 and resides within an opening 52 of the connector housing. Opening 52 allows the latch to resile upwardly and downwardly in order to allow the entry of a terminal within the cavity portion 18, as is known in the art. Finally latch 50 includes a free end 54, a camming surface 56 and a latching surface 58 as described in greater detail herein.

With respect still to FIG. 5, TPA 6 is defined by a front wall 60 having apertures 62 therethrough which together with cavity 18 define terminal receiving cavities 10 (FIG. 2). TPA 6 further includes a wall 66 which is complementary to central body portion 30 and includes a first surface 68 which complements surface 36, and an undercut surface 70 which complements surface 34. TPA 6 further includes a tine 72, as shown in FIG. 5 that includes a free end 74, and an integral cam member 76, having a camming surface 78.

TPA 6 also includes an integrated seal 80 which is integrally molded along a free end 82 of the TPA wall 66. The seal 80 defines an internal surface 90 and a plurality of ribs 92 which extend in a direction generally transverse to the longitudinal direction of the connector assembly 2. It should be appreciated that the TPA 6 would be comprised of an insulating material such as a plastic, whereas the seal is comprised of a sealing material, such as rubber, neoprene or the like.

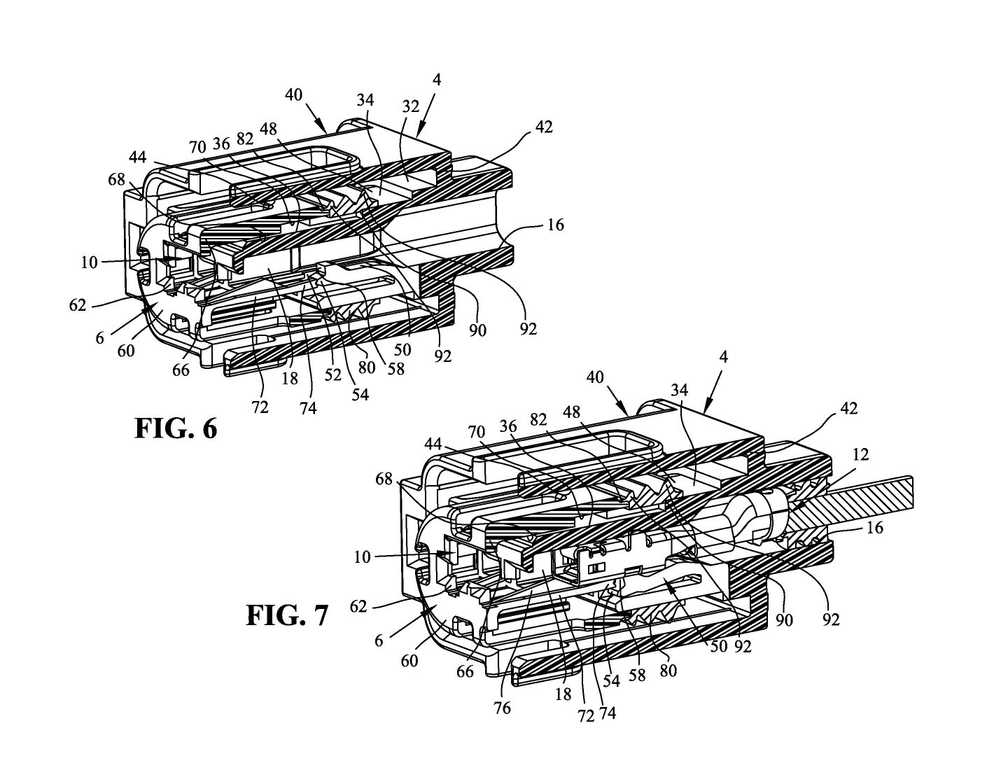

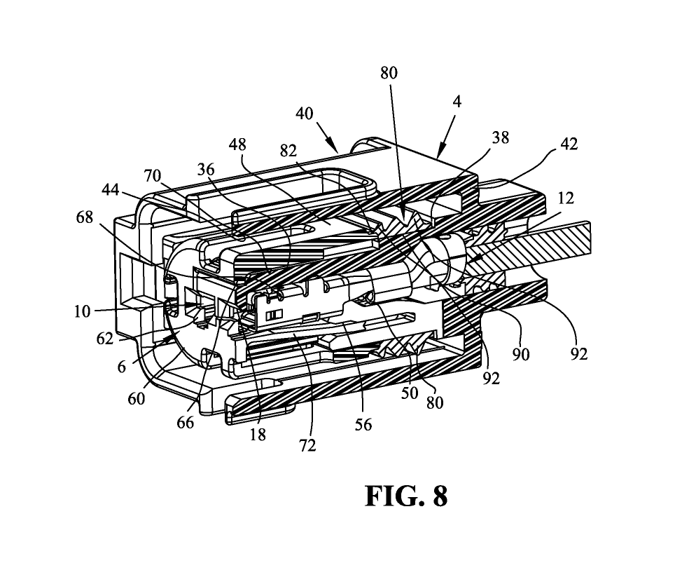

With the components as described above, the assembly of electrical connector assembly 2 will now be described. First, TPA 6 is positioned relative to connector housing 4 as shown in FIG. 5, and moved to a position shown in FIG. 6 where surfaces 68 and 70 may cooperate with surfaces 36 and 34, respectively, as described above. TPA 6 is movable to the position shown in FIG. 6 where free end 74 of tine 72 abuts the free end 54 of latch 50. At this point, electrical terminal 12 may be positioned in entry portion 16 and moved forwardly to deflect latch 50 downwardly as shown in FIG. 7. When electrical terminal 12 is moved further forward into the cavity portion 18, two events occur; first, and starting from the position shown in FIG. 7, electrical terminal 12 engages camming surface 78 (FIG. 5) of cam member 76 which deflects the entire tine 72 downwardly, thereby moving free end 74 away from the position shown in FIG. 7, and second, when electrical terminal 12 is fully loaded, latch 50 snaps back into the position shown in FIG. 6. TPA 6 may now move into the fully locked position as shown in FIG. 8, with tine 72 sliding against camming surface 56 and under latch 50. When TPA is in the fully locked position of FIG. 8, seal 80 is assured to be in its properly located position engaged against inner shoulder 38 and with surface 90 against surface 34 (FIG. 7).

It should be appreciated that the co-molding of the seal 80 provides for a simplified assembly process for the overall assembly, as well as assures that the seal is properly located relative to the axial locations. As shown in the assembled state of FIG. 8, an outer shroud 100 (FIG. 4) of mating connector 14 may be received in gap 48, and mating connector 14 may be moved into full electrical connection with connector assembly 2.

1. An electrical connector assembly, comprising:
a housing member comprising a housing central body portion defining a body surface, the body portion further comprising at least one terminal receiving cavity extending therethrough, and a wall portion overlying the body surface, defining a gap therebetween; and
an auxiliary housing portion, having an integrally molded seal attached thereon, the auxiliary housing portion being receivable in the gap together with the seal, with the seal generally overlying the body surface.

2. The electrical connector of claim 1, wherein the wall portion is defined by a shroud extending over said body surface.

3. The electrical connector of claim 2, wherein the shroud is integral with the housing body portion at a position rearward of said body surface, and extends forwardly.

4. The electrical connector of claim 3, wherein the shroud substantially circumscribes the housing body portion.

5. The electrical connector of claim 1, wherein the auxiliary housing portion comprises a terminal position assurance member (TPA).

6. The electrical connector of claim 5, wherein the TPA defines a wall complementary with the body surface, and has a free end, with the seal integrally molded to the free end.

7. The electrical connector of claim 5, wherein the housing body portion comprises latches for retaining the plurality of contacts, and the TPA further comprises tines receivable beneath the latches when in a fully locked position.

8. A sealed electrical connector, comprising:
a housing member comprising a housing body portion defining an outer wall having a body surface, and at least one terminal receiving cavity extending through the housing body portion, the housing member further comprising a shroud member overlying the body surface, and defining a gap therebetween; and
a terminal position assurance member (TPA) having a TPA wall receivable in the gap, and having a seal bondedly attached to a free end thereof, where the seal is positioned over the body surface, when the TPA wall is positioned over the outer wall.

9. The sealed connector of claim 8, wherein the seal is integrally molded to the free end of the TPA wall.

10. The sealed connector of claim 9, wherein the seal includes ribs which upstand in a direction substantially transverse to the TPA wall.

11. The sealed connector of claim 8, wherein the outer wall has at least one undercut portion and the TPA wall and seal seat in the undercut portion.

12. The sealed connector of claim 8, wherein the shroud generally circumscribes the housing body portion.

13. The sealed connector of claim 12, wherein the housing body portion defines a plurality of terminal receiving cavities.

14. A method of forming a sealed electrical connection, comprising the steps of:
molding overlying connector housing walls with a gap therebetween;
molding an auxiliary wall, and co-molding an integral seal to a free end of the auxiliary wall; and
inserting the auxiliary wall and integral seal into the gap, with the seal in substantial contact with one of the connector walls.

15. The method of claim 14, wherein the overlying connector walls are defined on an integral connector housing.

16. The method of claim 15, wherein one of said walls is defined on a connector housing body portion, and the other wall is defined by an integral shroud which overlies said connector body portion.
